(19) United States
(12) Patent Application Publication
(10) Pub. No.: US 2022/0195198 A1
(43) Pub. Date: Jun. 23, 2022

(54) METHOD OF PRODUCING COLORANT, PIGMENT COMPOSITION, AND AQUEOUS PIGMENT DISPERSION

(71) Applicant: DIC Corporation, Tokyo (JP)

(72) Inventor: Shoichi Hotate, Saitama (JP)

(21) Appl. No.: 17/538,945

(22) Filed: Nov. 30, 2021

(30) Foreign Application Priority Data
Dec. 22, 2020 (JP) 2020-212252

(51) Int. Cl. C09B 67/08; C09B 67/04; C09B 67/12; C09B 67/46

(52) U.S. Cl. CPC C09B 67/0013; C09B 67/0002; C09D 11/322; C09B 67/0091; C09B 67/0016

(57) ABSTRACT

An object of the present invention is to provide a method of efficiently producing a colorant that can be used for production of a pigment composition or an aqueous pigment dispersion with a small volume-average particle size of a dispersed substance and with fewer coarse particles. The inventor of the present invention has achieved the object by a method of producing a colorant that includes: step 1 of kneading a composition containing a pigment having a primary particle size of 100 nm or more, a liquid medium, and a water-soluble inorganic salt with a processing machine to produce a kneaded product containing a pigment having a primary particle size in a range of 10 nm or more and less than 100 nm; and step 2-1 of mixing the kneaded product, a resin having an anionic group, and a basic compound.

### BACKGROUND OF THE INVENTION

### 1. Field of the Invention

The present invention relates to a method of producing a colorant, a pigment composition, and an aqueous pigment dispersion that can be used, for example, in production of inkjet printing ink.

### 2. Description of the Related Art

Pigment compositions are used in a variety of printing such as inkjet printing. As a method of producing a pigment composition, it is known to process a raw material composition containing a pigment component and a liquid medium with a dispersing machine to obtain a pigment composition (for example, see Japanese Unexamined Patent Application Publication No. 2001-262038 below).

### SUMMARY OF THE INVENTION

A pigment composition is required to have a dispersed substance having a small volume-average particle size and have fewer coarse particles in terms of suppressing clogging of an ejection nozzle in printing and the like, and ensuring high ejection stability.

One of methods for producing a pigment composition with a small volume-average particle size of a dispersed substance and with fewer coarse particles is, for example, to repeatedly perform crushing and cracking of a raw material composition containing a pigment and a liquid medium. However, even this method may fail to further reduce the volume-average particle size of a dispersed substance, may fail to further reduce the number of coarse particles, and may lead to reduction in productivity of the pigment composition.

An object of the present invention is to provide a method of efficiently producing a colorant that can be used for production of a pigment composition or an aqueous pigment dispersion with a small volume-average particle size of a dispersed substance and with fewer coarse particles.

The inventor of the present invention has achieved the object by a method of producing a colorant that involves: step 1 of kneading a composition containing a pigment (A1) having a primary particle size of 100 nm or more, a liquid medium (D), and a water-soluble inorganic salt (E) with a processing machine (F) to produce a kneaded product containing a pigment (A2) having a primary particle size in a range of 10 nm or more and less than 100 nm, the liquid medium (D), and the water-soluble inorganic salt (E); and step 2-1 of mixing the kneaded product, a resin (B1) having an anionic group, and a basic compound (C) or step 2-2 of mixing the kneaded product and a resin (B2) having an anionic group neutralized by a basic compound (C). The pigment (A2) is coated with the resin (B1) or the resin (B2).

The colorant obtained by the production method according to the present invention can provide a pigment composition and an aqueous pigment dispersion with a small volume-average particle size of a dispersed substance and with fewer coarse particles.

### BRIEF DESCRIPTION OF DRAWINGS

FIG. 1 is a schematic cross section of an exemplary rotor-stator processing machine;

FIG. 2 is a schematic side view of an exemplary stator in the rotor-stator processing machine; and

FIG. 3 is a schematic diagram for explaining the processing in the rotor-stator processing machine.

### DETAILED DESCRIPTION OF EMBODIMENTS

Embodiments of the present invention will be described in detail below. However, the present invention is not limited to the following embodiments and can be modified in various ways and carried out without departing from the spirit of the invention.

In the present description, a numerical range denoted by “to” refers to a range including numerical values provided before and after “to” as the minimum value and the maximum value. In numerical ranges provided in stages in the present description, the upper limit value or the lower limit value of a numerical range in a certain stage may be combined as appropriate with the upper limit value or the lower limit value of a numerical range in another stage. In a numerical range provided in the present description, the upper limit value or the lower limit value of the numerical range may be replaced by a value listed in Examples. “A or B” is intended to include at least one of A and B and may include both. Materials illustrated by example in the present description can be used singly or in combination of two or more unless otherwise specified. If a plurality of substances corresponding to a component are contained in a composition, the amount of the component in the composition means the total amount of these substances contained in the composition, unless otherwise specified. The word “step” is not limited to an independent step and encompasses a step that is not clearly distinguishable from another step as long as the step achieves an intended effect. “(Meth)acrylic acid” refers to a generic name of acrylic acids and corresponding methacrylic acids, and the same applies to other similar expressions such as (meth)acrylate”.

A method of producing a colorant according to the present invention includes: step 1 of kneading a composition containing a pigment (A1) having a primary particle size of 100 nm or more, a liquid medium (D), and a water-soluble inorganic salt (E) with a processing machine (F) to produce a kneaded product containing a pigment (A2) having a primary particle size in a range of 10 nm or more and less than 100 nm, the liquid medium (D), and the water-soluble inorganic salt (E); and step 2-1 of mixing the kneaded product, a resin (B1) having an anionic group, and a basic compound (C) or step 2-2 of mixing the kneaded product and a resin (B2) having an anionic group neutralized by a basic compound (C). In the colorant produced by the method above, the pigment (A2) is partially or entirely coated with the resin (B1) or the resin (B2). The colorant can be suitably used for production of a pigment composition or an aqueous pigment dispersion with a small volume-average particle size of a dispersed substance and with fewer coarse particles.

First of all, step 1 will be described.

Step 1 is a step of kneading a composition containing a pigment (A1) having a primary particle size of 100 nm or more, a liquid medium (D), and a water-soluble inorganic salt (E) with a processing machine (F) to produce a kneaded product containing a pigment (A2) having a primary particle size in a range of 10 nm or more and less than 100 nm, the liquid medium (D), and the water-soluble inorganic salt (E). Step 1 is a step for miniaturizing the pigment (A1) having a primary particle size of 100 nm or more, commonly called a coarse pigment. The kneaded product obtained through step 1 therefore includes the pigment (A2) having a primary particle size in a range of 10 nm or more and less than 100 nm, in which the pigment (A1) is miniaturized.

The primary particle size of the pigment (A1) and the pigment (A2) is a value measured by the method described below.

A mixture of the pigment (A1) or the pigment (A2) and acetone was ultrasonically dispersed, and the dispersion was casted onto a grid mesh and dried to produce a sample. A surface of the sample was observed with a transmission electron microscope, and the diameters (maximum values) of 50 pigments were measured. The mean value of the diameters was calculated and set as a primary particle size.

Examples of the method of kneading a composition containing the pigment (A1), the liquid medium (D), and the water-soluble inorganic salt (E) with the processing machine (F) include (i) a method of supplying and kneading the pigment (A1), the liquid medium (D), and the water-soluble inorganic salt (E) in the processing machine (F), (ii) a method of supplying the pigment (A1) and the water-soluble inorganic salt (E) to the processing machine (F) and then supplying the liquid medium (D), followed by kneading, (iii) a method of supplying the pigment (A1) and the water-soluble inorganic salt (E) to the processing machine (F) and kneading for 5 to 10 minutes and thereafter supplying the liquid medium (D) and kneading again, and (iv) a method of supplying the water-soluble inorganic salt (E) to the processing machine (F) and kneading for 5 to 10 minutes, thereafter supplying the pigment (A1) and kneading, and thereafter supplying the liquid medium (D) and kneading the mixture again. Among these kneading methods, the method (iii) is preferable in miniaturizing the pigment (A1) into the pigment (A2) having a primary particle size of 10 nm or more and less than 100 nm efficiently in a short time.

For example, a kneader can be used as the processing machine (F). Among the kneaders, a double-arm kneader, a Tri-mix, or a kneading machine is preferably used as the processing machine (F) in miniaturizing the pigment (A1) into the pigment (A2) having a primary particle size of 10 nm or more and less than 100 nm efficiently in a short time, and a double-arm kneader is more preferably used.

At step 1, the temperature for kneading the composition with the processing machine (F) is preferably in a range of 30° C. to 120° C. and preferably in a range of 70° C. to 110° C. in miniaturizing the pigment (A1) into the pigment (A2) having a primary particle size of 10 nm or more and less than 100 nm efficiently in a short time.

At step 1, the time for kneading the composition with the processing machine (F) is preferably in a range of 2 hours to 24 hours, and preferably in a range of 5 hours to 9 hours in miniaturizing the pigment (A1) into the pigment (A2) having a primary particle size of 10 nm or more and less than 100 nm efficiently in a short time.

The kneaded product obtained through the step (1) contains the pigment (A2) in which the pigment (A1) is miniaturized. The primary particle size of the pigment (A2) is preferably 10 nm or more and less than 100 nm, preferably 10 nm or more and 80 nm or less, and preferably 10 nm or more and 60 nm or less because if so, the pigment (A2) can be stably dispersed in an aqueous medium readily in a short time at the step described later.

The kneaded product obtained through the step (1) contains the water-soluble inorganic salt (E) used to friction-grinding the pigment (A1) to produce the pigment (A2). In the present invention, the kneaded product containing the water-soluble inorganic salt (E) can be used as it is at step 2-1 or step 2-2 without removing the water-soluble inorganic salt (E) from the kneaded product obtained at step 1. The method according to the present invention therefore can drastically improve the production efficiency of a colorant, an aqueous pigment dispersion, and the like.

Step 2-1 and step 2-2 will now be described.

In the present invention, one of step 2-1 or step 2-2 is performed using the kneaded product obtained through step 1. Step 2-1 or step 2-2 can be performed to produce a colorant that can be used in production of a pigment composition or an aqueous pigment dispersion with a small volume-average particle size of a dispersed substance and with fewer coarse particles.

Step 2-1 is a step of mixing the kneaded product obtained at step 1, a resin (B1) having an anionic group, and a basic compound (C).

Examples of step 2-1 include a method of mixing a premixture of the resin (B1) having an anionic group and the basic compound (C) with the kneaded product and a method of mixing the kneaded product and the resin (B1) and thereafter supplying and mixing the basic compound (C).

Step 2-2 is a step of mixing the kneaded product and a resin (B2) having an anionic group neutralized by a basic compound (C).

Step 2-2 is, for example, a step of mixing the kneaded product with a resin obtained by mixing and stirring the resin (B1) having an anionic group and the basic compound (C) in advance to neutralize a part or the whole of the anionic group of the resin (B1) by the basic compound (C).

The mixing performed at the steps 2-1 and 2-2 is performed preferably for 0.5 hours to 5 hours and more preferably performed for 1 hour to 3 hours in producing a colorant by which the volume-average particle size of a dispersed substance included in an aqueous pigment dispersion can be reduced.

The mixing performed at the steps 2-1 and 2-2 is preferably performed by regulating the temperature of the ingredients such as the kneaded product, the resin (B1), the resin (B2), and the basic compound (C) in a range of 30° C. to 70° C. and more preferably performed in a range of 50° C. to 70° C. in producing a colorant by which the volume-average particle size of a dispersed substance included in an aqueous pigment dispersion can be reduced.

In the colorant obtained through step 1 and step 2-1 or step 2-2, a surface of the pigment (A2) is partially or entirely coated with the resin (B1) or the resin (B2). The colorant produced by the method above is in a wet state (what is called wet cake) and, therefore, a step of drying the colorant is not essential but is optional. This can enhance the production efficiency of the colorant.

The pigment (A1) used in the method of producing a colorant according to the present invention will now be described.

A coarse pigment having a primary particle size of 100 nm or more is usually used as the pigment (A1), as described above. The coarse pigment is often unsuitable as a coloring material. In the present step 1, the pigment (A1) is miniaturized whereby a kneaded product including the pigment (A2) having a primary particle size in a range of 10 nm or more and less than 100 nm, suitable as a coloring material, is produced.

Examples of the pigment (A1) include common pigments (azo pigments (including azo lake, insoluble azo pigments, condensation azo pigments, and chelate azo pigments), polycyclic pigments (for example, phthalocyanine pigments, perylene pigments, perinone pigments, anthraquinone pigments, quinacridon pigments, dioxazine pigments, thioindigo pigments, isoindolinone pigments, quinophthalone pigments), dye chelates (for example, basic dye chelates, acid dye chelates), nitro pigments, nitroso pigments, aniline black).

Among those, polycyclic pigments are preferably used, and phthalocyanine pigments are preferably used as the pigment (A1).

The liquid medium (D) used in the method of producing a colorant according to the present invention will now be described.

The liquid medium (D) is used in order to wet the pigment (A1) and the water-soluble inorganic salt (E) at step 1. A water-soluble organic solvent unlikely to dissolve the water-soluble inorganic salt (E) described later can be used as the liquid medium (D), for example, and specific examples include triethylene glycol, diethylene glycol, glycerol, ethylene glycol, propylene glycol, liquid polyethylene glycol, liquid polypropylene glycol, 2-(methoxymethoxy)ethanol, 2-butoxy ethanol, 2-(isopentyloxy)ethanol, 2-(hexyloxy)ethanol, diethylene glycol monomethyl ether, diethylene glycol monoethyl ether, diethylene glycol monobutyl ether, triethylene glycol, triethylene glycol monomethyl ether, 1-methoxy-2-propanol, 1-ethoxy-2-propanol, dipropylene glycol, dipropylene glycol monomethyl ether, dipropylene glycol monomethyl ether, dipropylene glycol, 1,2-propanediol, and 1-methoxy-2-propanol. Among those, diethylene glycol is more preferably used as the liquid medium (D) in miniaturizing the pigment (A1) into the pigment (A2) having a primary particle size of 10 nm or more and less than 100 nm efficiently in a short time and producing a colorant by which the volume-average particle size of a dispersed substance included in an aqueous pigment dispersion can be reduced.

The liquid medium (D) is used preferably in a range of 60 mass to 100 mass' with respect to the pigment (A1) included in the composition and more preferably in a range of 80 mass % to 100 mass % in miniaturizing the pigment (A1) into the pigment (A2) having a primary particle size of 10 nm or more and less than 100 nm efficiently in a short time.

The water-soluble inorganic salt (E) used in the method of producing a colorant according to the present invention will now be described.

The water-soluble inorganic salt (E) is used for friction-grinding the pigment (A1) to produce the pigment (A2) having a primary particle size of 10 nm or more and less than 100 nm. For example, sodium chloride, potassium chloride, and sodium nitrate can be used as the water-soluble inorganic salt (E). Among those, sodium chloride is preferably used as the water-soluble inorganic salt (E) in friction-grinding the pigment (A1) and efficiently generating the pigment (A2) having a primary particle size of 10 nm or more and less than 100 nm.

The water-soluble inorganic salt (E) is used preferably in the form of a solid in friction-grinding the pigment (A1) and efficiently generating the pigment (A2) having a primary particle size of 10 nm or more and less than 100 nm. Specifically, the water-soluble inorganic salt (E) to be used preferably has a primary particle size of 0.5 μm to 100 μm, more preferably 0.5 μm to 50 μm. The primary particle size refers to a value measured by a method similar to the method of measuring the primary particle size of the pigment (A1) and the pigment (A2).

The water-soluble inorganic salt (E) is used preferably in a range of 600 mass % to 900 mass % with respect to the pigment (A1) and more preferably in a range of 700 mass % to 800 mass % in friction-grinding the pigment (A1) and efficiently generating the pigment (A2) having a primary particle size of 10 nm or more and less than 100 nm.

The resin (B1) having an anionic group used at step 2-1 will now be described.

The resin (B1) is used for imparting satisfactory water dispersibility to the pigment (A2).

Examples of the anionic group of the resin (B1) include carboxyl group, sulfonic acid group, and phosphoric acid group. Examples of the resin (B1) include polyvinyl resins having an anionic group, polyester resins having an anionic group, amino resins having an anionic group, acrylic resins having an anionic group, epoxy resins having an anionic group, polyurethane resins having an anionic group, polyether resins having an anionic group, polyamide resins having an anionic group, unsaturated polyester resins having an anionic group, phenolic resins having an anionic group, silicone resins having an anionic group, fluorine based macromolecular compounds having an anionic group, and polysaccharide derivatives having an anionic group. It is more preferable to use acrylic resins having an anionic group in producing a colorant by which the volume-average particle size of a dispersed substance included in an aqueous pigment dispersion can be reduced.

Examples of the acrylic resins having an anionic group that can be used as the resin (B1) include styrene-acrylic acid copolymers such as styrene-(meth)acrylic acid copolymer, styrene-(meth)acrylic acid ester-(meth)acrylic acid copolymer, and (meth)acrylic acid ester-(meth)acrylic acid copolymer. Among those, it is more preferable to use a styrene-acrylic acid copolymer as the acrylic resin having an anionic group in producing an aqueous pigment dispersion excellent in water dispersion stability and in producing inkjet printing ink excellent in ejection stability because of a small volume-average particle size of a dispersed substance and fewer coarse particles.

A polymer of monomers including styrene and (meth)acrylic acid can be used as the styrene-acrylic acid copolymer. As the styrene-acrylic acid copolymer, a polymer having 50 to 90 mass % of a styrene-derived structural unit with respect to the total amount of the styrene-acrylic acid copolymer is preferably used, and a polymer having 70 to 90 mass % of a styrene-derived structural unit is more preferably used in producing an aqueous pigment dispersion excellent in water dispersion stability and in producing inkjet printing ink excellent in ejection stability because of a small volume-average particle size of a dispersed substance and fewer coarse particles.

As the resin (B1), a resin having a weight-average molecular weight of 5000 to 20000 is preferably used, and a resin having a weight-average molecular weight of 5500 to 15000 is more preferably used in producing an aqueous pigment dispersion excellent in water dispersion stability and in producing inkjet printing ink excellent in ejection stability because of a small volume-average particle size of a dispersed substance and fewer coarse particles.

As the resin (B1), a resin having an acid value of 50 to 300 is preferably used, and a resin having an acid value of 60 to 200 is more preferably used in producing an aqueous pigment dispersion excellent in water dispersion stability and in producing inkjet printing ink excellent in ejection stability because of a small volume-average particle size of a dispersed substance and fewer coarse particles.

The resin (B1) is used preferably in a range of 5 to 50 mass % with respect to the total amount of the pigment (A2) included in the kneaded product obtained at step 1, and more preferably in a range of 20 to 40 masse in producing an aqueous pigment dispersion excellent in water dispersion stability and in producing inkjet printing ink excellent in ejection stability because of a small volume-average particle size of a dispersed substance and fewer coarse particles.

For example, hydroxides of alkali metals, such as potassium hydroxide and sodium hydroxide, can be used as the basic compound (C) used at step 2-1. Among those, it is preferable to use potassium hydroxide as the basic compound (C) because it has excellent water dispersion stability and can further improve the ejection stability of inkjet printing ink.

It is preferable that the basic compound (C) is used in the amount to such an extent that the neutralization ratio of the acid group of the resin (B1) is 50 to 200%. The neutralization ratio refers a value calculated by the method below.

Neutralization ratio (%)=mass (g) of basic compound×56.11×100/resin acid value (mgKOH/g)×equivalent of basic compound (C)×mass (g) of resin (B1)×100

The resin (B2) having an anionic group neutralized by the basic compound (C) used at step 2-2 will now be described.

The resin (B2) used at step 2-2 is a product obtained by premixing the resin (B1) and the basic compound (C) usable at step 2-1 illustrated by example and neutralizing a part or the whole of the acid group of the resin (B1) with the basic compound (C). Therefore, those similar to those usable at step 2-1 illustrated by example can be used as the resin (B1) and the basic compound (C) used for producing the resin (B2).

The resin (B2) is preferably used in a range of 5 to 50 mass % with respect to the total amount of the pigment (A2) included in the kneaded product obtained at step 1 and more preferably used in a range of 20 to 40 mass % in producing an aqueous pigment dispersion excellent in water dispersion stability and in producing inkjet printing ink excellent in ejection stability because of a small volume-average particle size of a dispersed substance and fewer coarse particles.

The colorant obtained by the production method including step 1 and step 2-1 or step 2-2 can reduce the volume-average particle size of a dispersed substance included in a pigment composition or an aqueous pigment dispersion described later produced using the colorant and significantly reduce the number of coarse particles.

The colorant obtained by the production method including step 1 and step 2-1 or step 2-2 includes the water-soluble inorganic salt (E) used for friction-grinding the pigment (A1) and the liquid medium (D). It is preferable that the water-soluble inorganic salt (E) is removed as much as possible, because if a large amount of the water-soluble inorganic salt (E) is left in the colorant, the dispersibility of the colorant in an aqueous medium may be reduced.

As an example of the method of removing the water-soluble inorganic salt (E), the colorant obtained by the production method including step 1 and step 2-1 or step 2-2 is mixed with water, for example, at 60° C. to 80° C., and a solution of the water-soluble inorganic salt (E) in water is filtered.

In order to increase the proportion of the pigment (A2) partially or entirely coated with the resin (B1) or the resin (B2) and consequently produce a colorant that can be used for production of an aqueous pigment dispersion with even higher water dispersion stability, and the like, it is preferable that the colorant obtained by the production method including step 1 and step 2-1 or step 2-2 is mixed with an acid aqueous solution (G) to produce a precipitate, and this precipitate is used as a colorant.

In the present invention, therefore, in order to perform a filtration step for removing the water-soluble inorganic salt (E) and a step for producing the precipitate in a batch, it is preferable to produce the colorant through step 3 of mixing the colorant obtained by the production method including step 1 and step 2-1 or step 2-2 with water, for example, at 60° C. to 80° C. to dissolve the water-soluble inorganic salt (E) in water, and then supplying the acid aqueous solution (G) to produce a precipitate, which is then filtered, and washing the precipitate.

For example, a solution of hydrochloric acid or sulfuric acid in water can be used as the acid aqueous solution (G). The pH of the acid aqueous solution (G) is preferably 3 to 4. It is preferable to use an aqueous solution of hydrochloric acid as the acid aqueous solution (G) in precipitating the resin (B1) or the resin (B2) on a surface of the pigment (A2) and producing a colorant that enables production of a pigment composition or an aqueous pigment dispersion with a small volume-average particle size of a dispersed substance and with fewer coarse particles.

The aqueous solution of hydrochloric acid to be used preferably contains 0.5 to 5 mass % of hydrochloric acid with respect to the total amount of the aqueous solution of hydrochloric acid and more preferably contains 1 to 3 mass % of hydrochloric acid in precipitating the resin (B1) or the resin (B2) on a surface of the pigment (A2) and producing a colorant that enables production of a pigment composition or an aqueous pigment dispersion with a small volume-average particle size of a dispersed substance and with fewer coarse particles.

As an example of the method of mixing the colorant and the acid aqueous solution (G), a mixture of the colorant and water is produced in advance and the acid aqueous solution (G) is added dropwise to the mixture.

It is preferable that the dropwise addition of the acid aqueous solution (G) is performed, for example, at a rate of 100 cc to 800 cc per hour in precipitating the resin (B1) on a surface of the pigment (A2) and producing a colorant that enables production of a pigment composition or an aqueous pigment dispersion with a small volume-average particle size of a dispersed substance and with fewer coarse particles.

When the mixture including the colorant and water is mixed with the acid aqueous solution (G) by the method above, the colorant containing the pigment (A2) and the resin (B1) or the resin (B2) is precipitated. This colorant is in the form of wet cake in which a large part of the liquid medium (D) and the water-soluble inorganic salt (E) included in the colorant before step 3 has been removed. An example of the method of sufficiently removing the liquid medium (D) and the water-soluble inorganic salt (E) from the precipitate, the precipitate is washed with water preferably at 60° C. to 80° C.

In the colorant obtained through step 3, the water-soluble inorganic salt (E) and the like is removed, and the resin (B1) or the resin (B2) is precipitated on a part or the whole of the surface of the pigment (A2) and a part or the whole of the surface of the pigment (A2) is coated with resin (B1), thereby facilitating dispersion in an aqueous medium. The colorant can be used to produce a pigment composition or an aqueous pigment dispersion with a small volume-average particle size of a dispersed substance and with fewer coarse particles.

A method of producing a pigment composition using the colorant produced by the method above will now be described.

The pigment composition is obtained through step 4 of processing the colorant obtained through step 1 and step 2-1 or step 2-2, and if necessary, step 3, with a rotor-stator processing machine.

In the method of producing a pigment composition according to the present embodiment, a pigment composition can be produced through step 4 of mixing the colorant with an aqueous medium and the like using a rotor-stator processing machine. Step 4 is a step of producing a water dispersion to a degree that it can be charged into a high pressure homogenizer at step 5-1 or step 5-2 described later. In doing so, the colorant may be crushed or cracked at a first processing step. The crushing means, for example, breaking an integral mass. The cracking means, for example, disintegrating an agglomeration.

The pigment composition according to the present embodiment may be used for obtaining ink or may be used as ink. The pigment composition according to the present embodiment can be used, for example, as a pigment composition of printing ink (for example, inkjet printing ink).

A manufacturing apparatus for the pigment composition according to the present embodiment is a manufacturing apparatus for a pigment composition for ink and includes a first processing machine of a rotor-stator type to mix the colorant with an aqueous medium and the like, and a raw material supplying unit to supply the colorant and the like to the first processing machine. Hereinafter “first processing machine of a rotor-stator type” is simply referred to as “rotor-stator processing machine”.

In the rotor-stator processing machine, shearing force is applied to the colorant between a rotor and a stator as described later to crush or crack agglomerating coarse particles included in the colorant. In the method of producing a pigment composition and the manufacturing apparatus according to the present embodiment, the rotor-stator processing machine can be used to further reduce the number of coarse particles in the pigment composition efficiently and further reduce the number of coarse particles having a particle size of 1.0 μm or more. The method of producing a pigment composition and the manufacturing apparatus according to the present embodiment can suppress increase in processing time for producing a pigment composition with fewer coarse particles, thereby producing a pigment composition with even fewer coarse particles with high productivity. The method of producing a pigment composition and the manufacturing apparatus according to the present embodiment can also further reduce the number of coarse particles having a particle size of 0.5 μm or more.

The method of producing a pigment composition and the manufacturing apparatus according to the present embodiment can reduce the viscosity of the pigment composition to such a degree that the pigment composition can be charged to a high pressure homogenizer and can even further reduce the number of coarse particles in the pigment composition efficiently. The method of producing a pigment composition and the manufacturing apparatus according to the present embodiment can provide excellent preservation stability (dispersion stability of a solid content) in the pigment composition.

In the method of producing a pigment composition and the manufacturing apparatus according to the present embodiment, the rotor-stator processing machine can be used to achieve a high print density when compared under the condition that the composition of the resin (B1) or the resin (B2) and the mass ratio of the resin (B1) or the resin (B2) to the pigment (A2) are the same. With the method of producing a pigment composition and the manufacturing apparatus according to the present embodiment, a high adsorption ratio of the resin (B1) or the resin (B2) to the pigment (A2) can be achieved.

The temperature at step 4 preferably falls within the following range in terms of easily reducing the number of coarse particles efficiently, in terms of easily reducing the time required for step 5-1 and step 5-2, and in terms of accelerating dissolution of the resin (B1) or the resin (B2) to easily improve the adsorption ratio of the resin (B1) or the resin (B2) to the pigment (A2) and easily achieving excellent preservation stability. The temperature is preferably 25° C. or higher, more preferably 30° C. or higher, further preferably 40° C. or higher, particularly preferably 50° C. or higher, much preferably 55° C. or higher, and extremely preferably 60° C. or higher. The temperature is preferably 80° C. or lower, more preferably 75° C. or lower, further preferably 70° C. or lower, particularly preferably 65° C. or lower, and much preferably 60° C. or lower. From these points of view, the temperature is preferably 25 to 80° C., more preferably 50 to 80° C., further preferably 60 to 80° C.

The rotor-stator processing machine in the manufacturing apparatus for a pigment composition according to the present embodiment includes a rotor having a rotatable blade and a stator having a wall arranged on the outer peripheral side of the blade. The processing machine may be any one of a crushing machine, a cracking machine, a disperser, and the like. The rotor and the stator may be those commercially available and having any shape, and those having different shapes or the same shape may be used in combination. The combination can be selected according to the properties of the colorant because there are differences in colorant feeding characteristics, shear rate (miniaturization ability), and heating during miniaturization, depending on the shapes. Typically, a rotor with many teeth facilitates miniaturization and generates much heat.

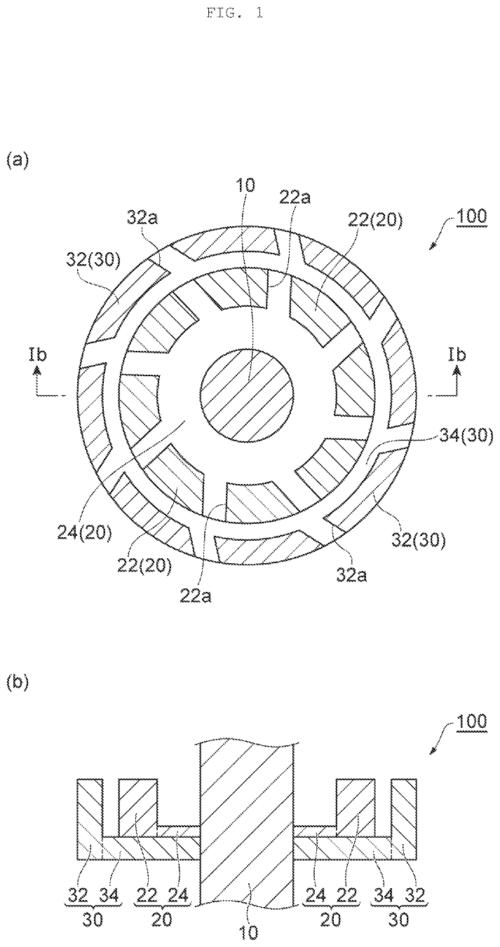

FIG. 1 (FIG. 1 (a) and FIG. 1 (b)) is a schematic cross section of an exemplary rotor-stator processing machine. A rotor-stator processing machine 100 illustrated in FIG. 1 includes a center shaft 10, a rotor 20, and a stator 30. Examples of the constituent material of the center shaft 10, the rotor 20, and the stator 30 include metal materials and ceramics.

The center shaft 10 is an elongated member and extends, for example, in the vertical direction. The center shaft 10 supports the rotor 20 and the stator 30.

The rotor 20 has an annular (for example, ring-shaped) blade 22 extending in the longitudinal direction of the center shaft 10 on the outer periphery of the rotor 20 and a connection part 24 connecting the blade 22 and the center shaft 10. The blade 22 can rotate around the center shaft 10. The blade 22 has an opening (through hole) 22a penetrating the blade 22 and, for example, has a plurality of openings 22a with spacings (for example, equal spacings) along the peripheral direction of the blade 22. The opening direction of the openings 22a may be inclined relative to the radial direction. An end portion on the vertically upper side of each opening 22a may be open with no member of the rotor 20 arranged thereon. The number, the arrangement, and the shape of the openings 22a are not limited.

The arrangement and the shape of the blade in the rotor of the rotor-stator processing machine are not limited. For example, the blade is not limited to an annular member arranged on the outer periphery of the rotor and may have a shape extending from the center to the outer periphery of the rotor. The rotor may have a plurality of blades having a shape extending from the center to the outer periphery of the rotor. The blade having a shape extending from the center to the outer periphery of the rotor may have a streamlined shape.

The stator 30 has an annular (for example, ring-shaped) wall 32 extending in the longitudinal direction of the center shaft 10 on the outer periphery of the stator 30 and a connection part 34 connecting the wall 32 and the center shaft 10. The wall 32 is arranged on the outer peripheral side of the blade 22 in the rotor-stator processing machine 100. The wall 32 has an opening (through hole) 32a penetrating the wall 32 and, for example, has a plurality of openings 32a with spacings (for example, equal spacings) along the peripheral direction of the wall 32. The opening direction of the opening 32a may be inclined relative to the radial direction.

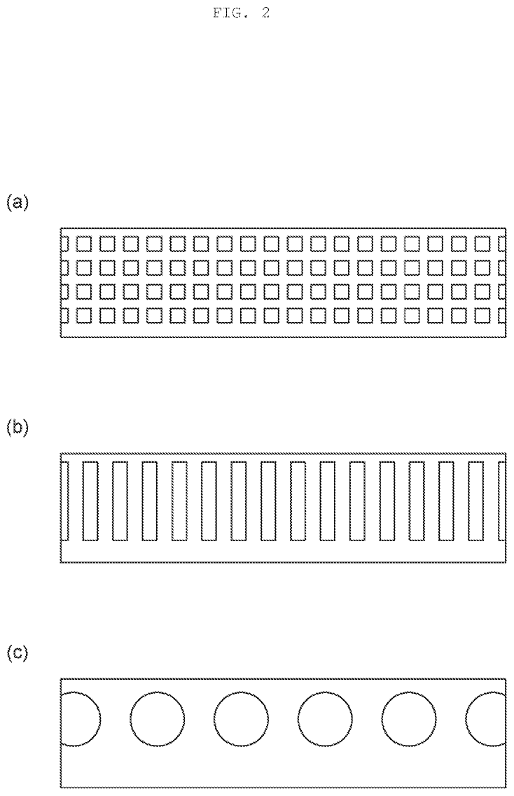

The number, the arrangement, and the shape of the opening of the wall in the stator are not limited. FIG. 2 is a schematic side view of an exemplary stator (the wall of the stator) in the rotor-stator processing machine. Examples of the wall of the stator include a wall having openings (for example, openings in a quadrangular shape such as a square) arranged in an array (FIG. 2 (a)), a wall having a plurality of rectangular openings arranged in a row (FIG. 2 (b)), and a wall having a plurality of circular (for example, exact circle) openings arranged in a row (FIG. 2 (c)). Examples of the shape of the openings include quadrangular shapes (square, rectangle, etc.) and circular shapes (exact circle, oval, etc.).

The stator may have a plurality of annular (for example, ring-shaped) walls extending in the longitudinal direction of the center shaft on the outer periphery of the stator. For example, the stator may include the wall 32 as a first wall, may include a second wall arranged on the outer peripheral side of the first wall in the rotor-stator processing machine, and may further include a third wall arranged on the outer peripheral side of the second wall in the rotor-stator processing machine. The number of walls is not limited and may be four or more.

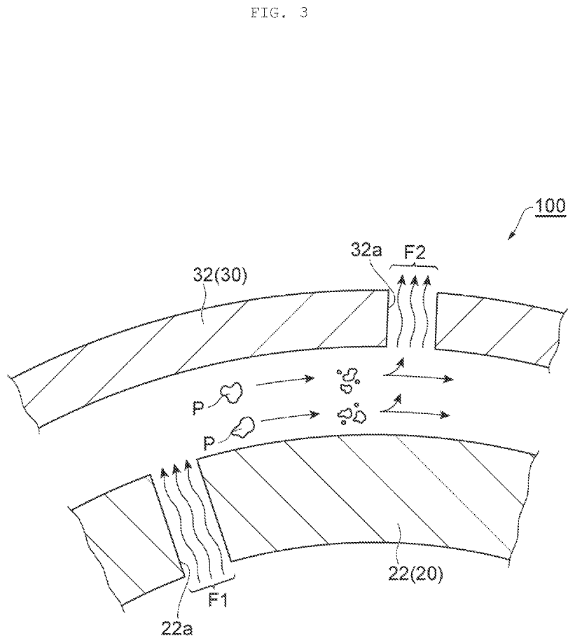

FIG. 3 is a schematic diagram for explaining the processing in the rotor-stator processing machine and illustrating a partially enlarged view of the rotor-stator processing machine 100 illustrated in FIG. 1. In the rotor-stator processing machine 100, for example, the colorant according to the present invention, if necessary, a basic compound, and if necessary, an aqueous medium are supplied to the periphery of the center shaft 10, and thereafter, as illustrated in FIG. 3, the colorant and, if necessary, the basic compound and the aqueous medium pass through the opening 22a (in the drawing, a channel F1) in the blade 22 of the rotor 20 to reach a space between the blade 22 and the wall 32 of the stator 30. Then, in this space, shearing force caused by rotational movement of the blade 22 disperses the colorant into the aqueous medium. This shearing force also crushes or cracks coarse particles P (solid content).

The shear rate (miniaturizing ability) applied by a processing unit including the rotor and the stator is preferably 50000 s⁻¹ or higher, more preferably 75000 s⁻¹ or higher, further preferably 90000 s⁻¹ or higher, particularly preferably 100000 s⁻¹ or higher, much preferably 120000 s⁻¹ or higher, extremely preferably 150000 s⁻¹ or higher, even more preferably 170000 s⁻¹ or higher in terms of easily reducing the number of coarse particles efficiently, in terms of easily reducing the particle size of the solid content after processing, in terms of easily reducing the viscosity of the pigment composition, and in terms of easily achieving excellent preservation stability in the pigment composition. The upper limit of the shear rate may be, for example, 400000 s⁻¹ or lower and may be 250000 s⁻¹ or lower. From these points of view, the shear rate is preferably 50000 to 400000 s⁻¹. The shear rate [s⁻¹] can be determined by dividing the circumferential speed [m/s] of the blade of the rotor by the spacing [m] between the blade and the wall of the stator.

The rotor-stator processing machine may have a plurality of processing units (crushers or crackers) each including a rotor and a stator. Feeding the colorant from a processing unit having a low shear rate to a processing unit having a high shear rate tends to suppress clogging and facilitates efficient reduction of the number of coarse particles. The rotor-stator processing machine may have a plurality of processing units (may have a multistage processing unit) along the center shaft extending in the vertical direction. When the rotor-stator processing machine has a plurality of processing units along the center shaft, it is preferable to arrange a processing unit having a higher shear rate as it is closer to the vertically lower side, in terms of easily reducing the number of coarse particles efficiently.

The rotor-stator processing machine may be an in-line processing machine or may be a batch processing machine. In the in-line processing machine, the colorant and the like are continuously supplied, and, for example, the processing machine may be installed in the middle of a processing path (for example, a pipe) to continuously process (crush or crack) a raw material composition. In the in-line processing machine, since the colorant and the like as a whole is forced to pass through the processing machine, the raw material composition as a whole can be easily processed uniformly in a short time, compared with a batch processing machine in which only the raw material composition around the rotor is processed. The in-line processing machine can easily reduce the number of coarse particles efficiently and therefore can easily suppress pipe clogging in the processing machine. The in-line processing machine easily reduces the viscosity of the pigment composition. In the in-line processing machine, the colorant and the like may be circulated. In the batch processing machine, the colorant and the like are intermittently supplied, and the colorant and the like are refilled in each process.

Examples of the rotor-stator processing machine include the apparatus name “magic LAB” from IKA Japan K.K. (in-line, maximum circumferential speed: 41 m/s, maximum rotational speed: 26000 rpm); the apparatus name “VERSO” from Silverson Nippon Limited (high shear in-line mixer, in-line, maximum circumferential speed: 20 m/s, maximum rotational speed: 10000 rpm); and the apparatus name “L5M-A” from Silverson Nippon Limited (batch, maximum circumferential speed: 20 m/s, maximum rotational speed: 10000 rpm). As a processing machine from IKA Japan K.K., a processing machine including UTR module (ULTRA-TURRAX), DR module (DISPAX-REACTOR), MK module, MKO module, or CMX module can be used. The DR module has three stages of processing units (stages) each including a rotor and a stator and can easily reduce the number of coarse particles efficiently, because the shear rate can be adjusted by a combination of rotors and stators. For example, when 2P/4M/6F processing units are used in order from the vertically upper side, the processing units can be arranged such that the shear rate increases toward the vertically lower side.

The manufacturing apparatus for a pigment composition according to the present embodiment may have any raw material supply unit that can supply the colorant and the like to the rotor-stator processing machine. The raw material supply unit may be, for example, a pipe and a pump that supplies a raw material supply unit.

The pigment composition obtained at step 4 can be used for production of an aqueous pigment dispersion. In the aqueous pigment dispersion, the colorant included in the pigment composition is dispersed in water. The aqueous pigment dispersion can be produced by step 5-1 of allowing the pigment compositions obtained at step 4 to collide with each other at an oblique angle or step 5-2 of allowing the pigment composition against a ball-shaped hard body rotatably supported. A second processing machine usable at step 5-1 and step 5-2 can further reduce the number of coarse particles in the aqueous pigment dispersion efficiently and can easily adjust the physical properties of the solid content (the number of coarse particles, the particle size, etc.) to desired physical properties. A manufacturing apparatus for the aqueous pigment dispersion according to the present embodiment may include a supply unit (pipe, pump, etc.) that supplies the pigment composition obtained at step 4 to the second processing machine.

Examples of the second processing machine include high pressure homogenizer, paint shaker, beads mill, roll mill, sand mill, ball mill, attritor, basket mill, sand mill, sand grinder, dyno mill, DISPERMAT, SC mill, spike mill, agitator mill, juice mixer, ultrasonic homogenizer, nanomizer, dissolver, disperser, high speed impeller disperser, kneader, and planetary mixer. For example, the apparatus name “Star Burst” from Sugino Machine Limited can be used as the high pressure homogenizer. The pressure in the high pressure homogenizer is preferably 50 to 245 MPa, more preferably 80 to 200 MPa, further preferably 100 to 200 MPa, particularly preferably 130 to 200 MPa. When the pigment component includes carbon black, the processing at low pressure is possible, and the longer service life of the apparatus and improvement in production volume per unit time can be easily achieved.

The second processing machine is a processing machine that allows the pigment compositions obtained at step 4 to collide with each other at an oblique angle to yield an aqueous pigment dispersion in which the colorant is dispersed in water. In this case, for example, the second processing machine may have an oblique-type collision chamber. The pigment compositions obtained at step 4 are injected under pressure from multiple directions to allow the pigment compositions obtained at step 4 to collide with each other.

The second processing machine is a processing machine that allows the pigment composition obtained at step 4 to collide with a ball-shaped hard body rotatably supported (for example, supported with a bearing) to yield an aqueous pigment dispersion in which the colorant included in the pigment composition is dispersed in water. In this case, for example, the second processing machine may have a ball-type collision chamber. The pigment composition obtained at step 4 is injected under pressure to allow the pigment composition obtained at the first processing step to collide with the hard body. The hard body may be rotatably supported eccentrically from an injection axis. Examples of the material of the hard body include ceramic and sintered diamond.

Examples of a chamber used in the second processing machine include, in addition to an oblique-type collision chamber and a ball-type collision chamber, separation chamber, single nozzle chamber, and slit chamber. An example of these chambers is a chamber of the apparatus name “Star Burst” from Sugino Machine Limited. It is preferable to use an oblique-type collision chamber to avoid wear of the hard body over long-time use in the oblique-type collision chamber and to derive shearing force higher than that of a chamber (for example, single-nozzle chamber) not using the force of collision.

The aqueous pigment dispersion produced by the method above can be used for production of ink. Among others, it is preferable that the aqueous pigment dispersion is used for production of inkjet printing ink.

### EXAMPLES

(Styrene-Acrylic Acid Copolymer A)

In a reaction vessel with a stirring apparatus, a dropping apparatus, and a reflux apparatus, 100 parts by mass of methyl ethyl ketone was charged and then stirred while the reaction vessel was purged with nitrogen.

Subsequently, the reaction vessel was heated, and with methyl ethyl ketone being refluxed, a mixture of 72 parts by mass of styrene, 12 parts by mass of acrylic acid, 16 parts by mass of methacrylic acid, and 8 parts by mass of a polymerization catalyst (trade name: V-59 from Wako Pure Chemical Industries, Ltd.) was dropwise added from the dropping apparatus over 2 hours. In the middle of dropwise addition, the temperature in the reaction vessel was kept at 80° C. After completion of dropwise addition, the reaction was allowed to continue at the same temperature for additional 25 hours. After the end of reaction, the inside of the reaction vessel was left to cool and then methyl ethyl ketone was added to produce a solution with a solid content concentration of 50 mass %. After this solution was dried, the dried product was crushed into powder of 1 mm or smaller to yield a styrene-acrylic acid copolymer A. The styrene-acrylic acid copolymer A had an acid value of 180 mgKOH/g and a weight-average molecular weight of 9000.

The weight-average molecular weight is a value measured by gel permeation chromatography (GPC) and a value converted in terms of the molecular weight of polystyrene used as a standard substance. The measurement was performed by the apparatus under the conditions below.

Liquid feeding pump: LC-9A (from Shimadzu Corporation)

System controller: SLC-6B (from Shimadzu Corporation)

Auto injector: S1L-6B (from Shimadzu Corporation)

Detector: RID-6A (from Shimadzu Corporation)

Data processing software: Sic480II data station (from System Instruments Co., Ltd.)

Column: GL-R400 (guard column)+GL-R440+GL-R450+GL-R400M (from Hitachi Chemical Company, Ltd.)

Elution solvent: THE (tetrahydrofuran)

Elution flow rate: 2 mL/min

Column temperature: 35° C.

### Example 1

(Step 1)

In a double-arm kneader (from YOSHIDA MANUFACTURING CO., LTD.) having a capacity of 1 L, 400 g of sodium chloride and 53.25 g of a phthalocyanine pigment (coarse pigment, β crude, Pigment Blue 15:3) having a primary particle size of 1000 nm or more was charged. The operation was temporarily stopped after 5 minutes, and 48.75 g of diethylene glycol, 0.6 g of sodium hydroxide (granule), and 1.2 g of xylene were charged, and the operation was started at a setting temperature of 94° C.

Seven hours after start of operation, the kneaded product in the vessel was sampled, and it was confirmed that the primary particle size of the phthalocyanine pigment fell into a range of 10 nm or more and 60 nm or less. Step 1 was then finished.

(Step 2-1)

After the setting temperature of the kneader was changed to 60° C., 16 g of the styrene-acrylic acid copolymer A as the resin having an anionic group, 6 g of an aqueous solution of 48 masse potassium hydroxide, and 29.8 g of diethylene glycol were added to the kneaded product obtained at step 1, and the mixture was kneaded for 2 hours to yield a colorant having the pigment coated with the resin having an anionic group.

(Step 3)

The colorant obtained at step 2-1 was adjusted with hot water at 70° C. to a pigment concentration of 2 mass %, and thereafter hydrochloric acid having a concentration of 2 mass % was added dropwise with a burette. The dropwise addition was performed at a rate of 200 cc/0.5 hours. The dropwise addition was stopped at the point of time when the pH of the colorant reached 3.8.

The colorant obtained by the method above was filtered using filter paper (Advantec No. 4) and a Büchner funnel. Subsequently, the colorant having the pigment coated with the resin having an anionic group that was left on the surface of the filter paper was washed with pure water. The washing was performed until the electrical conductivity of water after washing the colorant (filtrate) reached 200 μS/cm or lower.

The washing by the method above yielded a colorant in the form of wet cake having a pigment concentration of 24.5 mass %.

(Step 4)

Pure water was supplied to the colorant obtained by the method above to produce a colorant having a pigment concentration of 15 mass %. A mixture of 100 g of the colorant having a pigment concentration of 15 mass % (pure water was added to make the 24.5% wet cake into a 15% wet cake) and 2.4 g of an aqueous solution of 34 mass % potassium hydroxide was charged into a rotor-stator processing machine (apparatus name: L5M-A from Silverson Nippon Limited, square-hole high shear screen, batch). Subsequently, with heating to 60° C., the processing was performed at a circumferential speed of 16 m/s (shear rate: 87000 s⁻¹) and a rotational speed of 8000 rpm for 10 minutes to yield a pigment composition.

(Step 5)

Subsequently, the pigment composition obtained at step 4 was processed with a high pressure homogenizer (apparatus name: Star Burst from Sugino Machine Limited, ball-type collision chamber, 240 MPa, 1 pass) to yield an aqueous pigment dispersion.

### Example 2

An aqueous pigment dispersion was produced by a method similar to that of Example 1 except that the amount of styrene-acrylic acid copolymer A was changed from 16 g to 26.6 g and the amount of aqueous solution of 48 mass % potassium hydroxide was changed from 6 g to 9.98 g at step 2-1, that a pigment composition in the form of wet cake having a pigment concentration of 24.7 mass % was produced instead of the pigment composition in the form of wet cake having a pigment concentration of 24.5 mass % at step 3, and that the amount of aqueous solution of 48 mass % potassium hydroxide was changed from 6 g to 9.98 g at step 4.

### Example 3

An aqueous pigment dispersion was produced by a method similar to that of Example 1 except that step 2-2 below was performed instead of step 2-1 and that a pigment composition in the form of wet cake having a pigment concentration of 24.1 mass % was produced instead of the pigment composition in the form of wet cake having a pigment concentration of 24.5 mass % at step 3.

(Step 2-2)

After step 1 was finished, the setting temperature of the kneader was changed to 60° C. Subsequently, an aqueous solution of the resin having an anionic group neutralized by potassium hydroxide was obtained by stirring and mixing 16 g of the styrene-acrylic acid copolymer A used as a resin having an anionic group, 6 g of an aqueous solution of 48 mass % potassium hydroxide, and 50 g of pure water.

Subsequently, 82 g of the aqueous solution and 29.8 g of diethylene glycol were mixed and kneaded for 2 hours to produce a colorant having the pigment coated with the neutralized resin having an anionic group.

### Example 4

An aqueous pigment dispersion was produced by a method similar to that of Example 1 except that a Tri-mix (from INOUE MFG., INC.) having a capacity of 2 L was used instead of the kneader (from YOSHIDA MANUFACTURING CO., LTD.) having a capacity of 1 L.

### Comparative Example 1

(Step 1)

In a kneader (from YOSHIDA MANUFACTURING CO., LTD.) having a capacity of 1 L, 53.25 g of a phthalocyanine pigment (coarse pigment, β crude, Pigment Blue 15:3) having a primary particle size of 1000 nm or more, 400 g of sodium chloride, 48.75 g of diethylene glycol, 0.6 g of sodium hydroxide (granule), and 1.2 g of xylene were charged, and the operation was started at a setting temperature of 94° C.

Seven hours after start of operation, the kneaded product in the vessel was sampled, and it was confirmed that the primary particle size of the phthalocyanine pigment was 10 nm or more and 60 nm or less. Step 1 was then finished.

(Other Steps)

The kneaded product obtained at step 1 was removed from the kneader and adjusted with hot water at 70° C. to a pigment concentration of 2 mass %, and thereafter hydrochloric acid having a concentration of 2 mass % was added dropwise with a burette to produce a colorant. The dropwise addition was performed at a rate of 200 cc/0.5 hours. The dropwise addition was stopped at the point of time when the pH of the colorant reached 3.8.

The colorant obtained by the method above was filtered using filter paper (Advantec No. 4) and a Büchner funnel. Subsequently, the pigment and the like left on the surface of the filter paper were washed with pure water. The washing was performed until the electrical conductivity of water after washing (filtrate) reached 200 μS/cm or lower.

The washing by the method above yielded a colorant in the form of wet cake having a pigment concentration of 25 mass %.

(Step 4)

Pure water was supplied to the colorant obtained by the method above to produce a colorant having a pigment concentration of 15 mass %. A mixture of 100 g of the colorant having a pigment concentration of 15 mass % and 2.4 g of an aqueous solution of 34 mass % potassium hydroxide was charged into a rotor-stator processing machine (apparatus name: L5M-A from Silverson Nippon Limited, square-hole high shear screen, batch). Subsequently, with heating to 60° C., the processing was performed at a circumferential speed of 16 m/s (shear rate: 87000 s⁻¹) and a rotational speed of 8000 rpm for 10 minutes to yield a pigment composition.

(Step 5)

Subsequently, the pigment composition obtained at step 4 was processed with a high pressure homogenizer (apparatus name: Star Burst from Sugino Machine Limited, ball-type collision chamber, 240 MPa, 1 pass) to yield an aqueous pigment dispersion.

### Measurement Method of Primary Particle Size of Pigment

A mixture of the pigment and acetone at a pigment concentration of 0.1 mass % was ultrasonically dispersed for 10 minutes, and the dispersion was casted and dried on a grid mesh to form a sample. A surface of the sample was observed with a transmission electron microscope, and the diameters (maximum values) of 50 pigments were measured. The mean value of the diameters was calculated and set as a primary particle size.

### Measurement Method of Particle Size of Dispersed Substance Included in Aqueous Pigment Dispersion

The aqueous pigment dispersion was put into a cell of about 4 mL. The particle size was measured by detecting scattering light of laser light under an environment at 25° C. using a NANOTRAC particle size distribution measuring apparatus “UPA150” from MicrotracBEL Corporation. The volume-average particle size (Mv), the number-average particle size (Mn), D50, D90, and D95 were measured as particle sizes.

### Measurement Method of Number of Coarse Particles of Dispersed Substance Included in Aqueous Pigment Dispersion

The number of particles with a diameter exceeding 1.0 μm and the number of particles with a diameter exceeding 0.5 μm were counted using a particle size distribution measuring apparatus (Accusizer 780 APS from Particle Sizing Systems, number count) by the following procedure. The aqueous pigment dispersion was diluted with pure water such that the sensitivity was within a range of 1000 to 4000 particles/mL. The number of particles with a diameter exceeding 1.0 μm and the number of particles with a diameter exceeding 0.5 μm included in the diluted aqueous pigment dispersion were counted three times using a particle size distribution measuring apparatus. Subsequently, the mean value of values each obtained by multiplying the measured value of particle count by a dilution concentration was calculated as the number of coarse particles.

| | | | | | | Number of coarse | |
|---|---|---|---|---|---|---|---|
| | Particle size (nm) | | | | | particles (×10⁶/mL) | |
| | Mv | Mn | D50 | D90 | D95 | >0.5 μm | >1.0 μm |
| Example 1 | 95 | 62 | 90 | 145 | 165 | 7200 | 450 |
| Example 2 | 98 | 64 | 97 | 147 | 179 | 8000 | 500 |
| Example 3 | 99 | 65 | 95 | 149 | 169 | 8500 | 500 |
| Example 4 | 98 | 63 | 99 | 149 | 175 | 8200 | 480 |
| Comparative | 122 | 83 | 113 | 179 | 211 | 12000 | 700 |
| Example 1 | | | | | | | |

What is claimed is:

1. A method of producing a colorant, the method comprising:
step 1 of kneading a composition containing a pigment (A1) having a primary particle size of 100 nm or more, a liquid medium (D), and a water-soluble inorganic salt (E) with a processing machine (F) to produce a kneaded product containing a pigment (A2) having a primary particle size in a range of 10 nm or more and less than 100 nm, the liquid medium (D), and the water-soluble inorganic salt (E); and
step 2-1 of mixing the kneaded product, a resin (B1) having an anionic group, and a basic compound (C), or step 2-2 of mixing the kneaded product and a resin (B2) having an anionic group neutralized by a basic compound (C), wherein
the pigment (A2) is coated with the resin (B1) or the resin (B2).

2. The method of producing a colorant according to claim 1, wherein the processing machine (F) is a double-arm kneader or a kneading machine.

3. A method of producing a colorant, the method comprising step 3 of mixing a colorant produced by the method according to claim 1 or 2 and an acid aqueous solution (G) to produce a precipitate and thereafter washing the precipitate, wherein
the pigment (A2) is coated with the resin (B1) or the resin (B2).

4. A method of producing a pigment composition, the method comprising step 4 of processing a colorant produced by the method according to claim 3 with a rotor-stator processing machine.

5. The method of producing a pigment composition according to claim 4, wherein the rotor-stator processing machine is an in-line processing machine into which the colorant is continuously supplied.

6. A method of producing an aqueous pigment dispersion, the method comprising step 5-1 of allowing pigment compositions produced by the method according to claim 4 or 5 to collide with each other at an oblique angle or step 5-2 of allowing the pigment composition to collide with a ball-shaped hard body rotatably supported.
